(19) United States
(12) Patent Application Publication
(10) Pub. No.: US 2021/0230906 A1
(43) Pub. Date: Jul. 29, 2021

(54) POSITION INDICATOR FOR BALL LOCK

(71) Applicant: GOODRICH CORPORATION, Charlotte, NC (US)

(72) Inventors: Timothy C. Haynes, Prescott Valley, AZ (US); Drew Hartman, Phoenix, AZ (US)

(73) Assignee: GOODRICH CORPORATION, Charlotte, NC (US)

(21) Appl. No.: 16/751,611

(22) Filed: Jan. 24, 2020

(51) Int. Cl. E05B 63/12; B64D 25/08

(52) U.S. Cl. CPC E05B 63/121; E05Y 2900/502; B64D 25/08

(57) ABSTRACT

A ball lock includes a body having a shaft with at least one retention feature disposed at a distal portion of the shaft. The body of the ball lock may also define a central chamber and an access slot open to the central chamber. The ball lock may include a spindle disposed within the central chamber of the body. The spindle may be in either a locked position or an unlocked position. The ball lock may further include an indicator coupled to the spindle and viewable to a user via the access slot, wherein the indicator is configured to indicate to the user whether the spindle is in the locked position or the unlocked position.

### FIELD

The present disclosure relates to aircraft systems, and in particular to ball locks for retaining blowout panels for evacuation assemblies.

### BACKGROUND

Emergency evacuation systems may be used to exit an aircraft absent a jet way or other suitable means of egress for passengers. The evacuation system may deploy from the side of an aircraft fuselage, for example through a compartment assembly having a blowout panel and a packboard. Conventional evacuation systems/assemblies generally include one or more attachment fixtures, such as ball locks, to securely retain the blowout panel until an evacuation event warrants deployment of the contained evacuation slide.

### SUMMARY

In various embodiments, the present disclosure provides a ball lock. The ball lock may include a body having a shaft with at least one retention feature disposed at a distal portion of the shaft. The body may also define a central chamber and an access slot open to the central chamber. A spindle may be disposed within the central chamber of the body, the spindle comprising a distal end configured to selectively engage the at least one retention feature disposed at the distal portion of the shaft, wherein in response to the spindle being in a locked position within the central chamber, the distal end of the spindle engages the at least one retention feature to hold the at least one retention feature in an expanded state. In response to the spindle being in an unlocked position within the central chamber, the distal end of the spindle is withdrawn from the at least one retention feature to allow the at least one retention feature to be in a compressed state. The ball lock may further include an indicator coupled to the spindle and viewable to a user via the access slot, wherein the indicator is configured to indicate to the user whether the spindle is in the locked position or the unlocked position.

In various embodiments, the indicator includes at least one of a colored pattern, a series of numbers/letters, and one or more symbols viewable through the access slot to indicate the position of the spindle. In various embodiments, the indicator is a portion of the spindle. In various embodiments, the indicator is a sleeve coupled to a portion of the spindle. The access slot, through which the indicator is visible to the user, may be a hole for insertion of a key actuator. In various embodiments, the indicator comprises a tab extending from the spindle through the access slot, wherein the position of the tab relative to the slot is indicative of the position of the spindle. For example, the spindle may include a proximal end having a first surface facing a biasing spring and a second surface opposite the first surface, and the tab may extend from the second surface. In various embodiments, the indicator is a position sensor configured to detect a position of the spindle.

Also disclosed herein, according to various embodiments, is an evacuation assembly of an aircraft. The evacuation assembly includes a packboard comprising a top panel and a bottom panel that collectively define a compartment, a ball lock coupled to the top panel of the packboard, and a blowout panel selectively coupled to the ball lock, according to various embodiments. The ball lock may comprise an indicator configured to indicate to a user whether the ball lock is in a locked position or an unlocked position. The indicator may be viewable by the user from an inboard position relative to the aircraft.

Also disclosed herein, according to various embodiments, is an aircraft that includes an evacuation slide held in a stored state within a compartment of a packboard. The packboard may comprise a top panel and a bottom panel that collectively define the compartment. The aircraft may further include a ball lock coupled to the top panel of the packboard, a position sensor coupled to the ball lock, and a blowout panel selectively coupled to the ball lock. The position sensor may be configured to detect a position of the ball lock and to send a feedback control signal to an aircraft controller.

The forgoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

FIG. 1 illustrates a perspective view of an evacuation system, in accordance with various embodiments;

FIG. 2 illustrates a perspective view of a portion of an aircraft, in accordance with various embodiments;

FIGS. 3A and 3B illustrate perspective views of a blowout panel, in accordance with various embodiments;

FIG. 4 illustrates a perspective view of a packboard compartment, in accordance with various embodiments;

FIG. 5 illustrates a perspective view of a compartment assembly during assembly, in accordance with various embodiments;

FIG. 6A is a perspective view of a ball lock, in accordance with various embodiments;

FIG. 6B is a cross-sectional view of a ball lock, in accordance with various embodiments;

FIG. 7A is a cross-sectional view of a ball lock in a locked position, in accordance with various embodiments; and

FIG. 7B is a cross-sectional view of a ball lock in an unlocked position, in accordance with various embodiments.

The subject matter of the present disclosure is particularly pointed out and distinctly claimed in the concluding portion of the specification. A more complete understanding of the present disclosure, however, may best be obtained by referring to the detailed description and claims when considered in connection with the drawing figures.

### DETAILED DESCRIPTION

The detailed description of exemplary embodiments herein makes reference to the accompanying drawings, which show exemplary embodiments by way of illustration. While these exemplary embodiments are described in sufficient detail to enable those skilled in the art to practice the disclosure, it should be understood that other embodiments may be realized and that logical changes and adaptations in design and construction may be made in accordance with this disclosure and the teachings herein without departing from the spirit and scope of the disclosure. Thus, the detailed description herein is presented for purposes of illustration only and not of limitation.

As used herein, “aft” refers to the direction associated with the tail (i.e., the back end) of an aircraft, or generally, to the direction of exhaust of the gas turbine. As used herein, “forward” refers to the direction associated with the nose (i.e., the front end) of an aircraft, or generally, to the direction of flight or motion. As used herein, “distal” refers to the direction outward, or generally, away from a reference component. As used herein, “proximal” and/or “proximate” refers to a direction inward, or generally, towards the reference component.

Disclosed herein, according to various embodiments, is a ball lock that comprises an indicator configured to indicate to a user whether the ball lock is in a locked position or an unlocked position. Said differently, the ball lock disclosed herein is generally configured with an indicator that enables a user to determine if the ball lock is properly engaged/locked. Though numerous details are included herein pertaining to implementing the disclosed ball lock and indicator for securely retaining a blowout panel of a packboard for an evacuation assembly for an aircraft, the disclosure is not necessarily so limited. That is, the scope of the present disclosure is not necessarily limited to ball locks for aircraft evacuation assemblies.

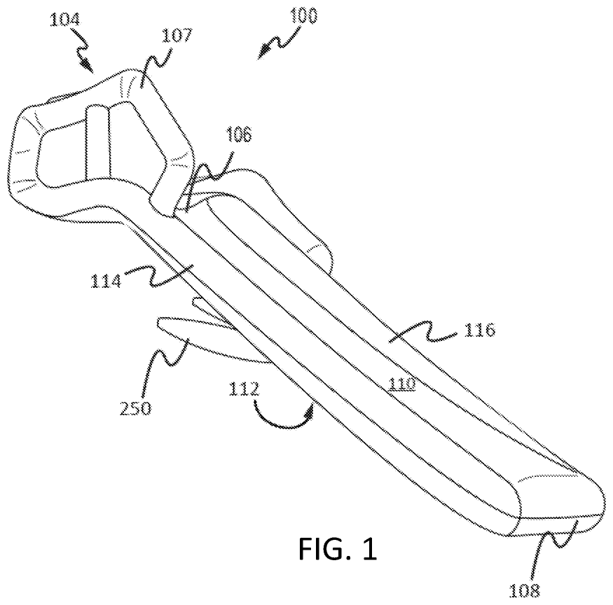

In various embodiments, and with reference to FIG. 1, an evacuation system 100 is provided. The Evacuation system 100 may comprise an evacuation slide 104. Evacuation slide 104 may comprise a head end 106 and a toe end 108, opposite head end 106. Head end 106 may be coupled to an aircraft structure. In various embodiments, a railing structure 107 may be coupled to head end 106. Evacuation slide 104 may comprise an inflatable slide. FIG. 1 illustrates evacuation slide 104 in an inflated and/or deployed position. Evacuation slide 104 may comprise a sliding surface 110 and an underside surface 112, opposite sliding surface 110. Sliding surface 110 may extend from head end 106 to toe end 108. Railing structure 107 may provide a lead-in to sliding surface 110. Evacuation slide 104 may comprise an outboard tube 114 and an inboard tube 116. Outboard tube 114 and inboard tube 116 may be disposed on opposing sides of evacuation slide 104. Outboard tube 114 and inboard tube 116 may be integrally formed and in fluid communication. Stated differently, outboard tube 114 and inboard tube 116 may be part of a one interconnected chamber that fills with gas upon deployment of evacuation slide 104. Evacuation slide 104 may comprise a single lane slide. However, evacuation slide 104 may comprise any number of lanes. Toe end 108 may contact an exit surface (e.g., the ground) in response to evacuation slide 104 being deployed.

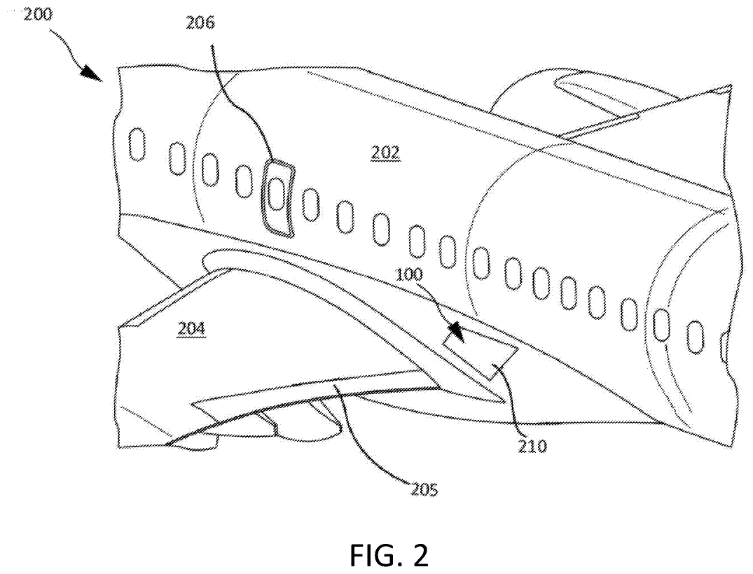

Referring to FIG. 2, an exemplary aircraft 200 with evacuation system 100 in a stowed position is shown, in accordance with various embodiments. Aircraft 200 may comprise a fuselage 202 with wings 204 fixed to fuselage 202. Wings 204 may include one or more flaps 205. Emergency exit door 206 may be disposed on fuselage 202 over wing 204 such that passengers exiting emergency exit door 206 would exit onto wing 204. Evacuation system 100 may be installed on the aircraft 200 and may be disposed aft of emergency exit door 206. A blowout panel 210 may cover evacuation system 100. In this regard, with combined reference to FIG. 1 an FIG. 2, evacuation slide 104 may be stowed behind blowout panel 210. In various embodiments, evacuation slide 104 may be folded, when in the stowed position. In response to emergency exit door 206 opening or in response to another evacuation event, evacuation system 100 may jettison blowout panel 210 and evacuation slide 104 may be deployed. In various embodiments, evacuation system 100 may include and/or be housed within a packboard, which may be mounted to aircraft 200.

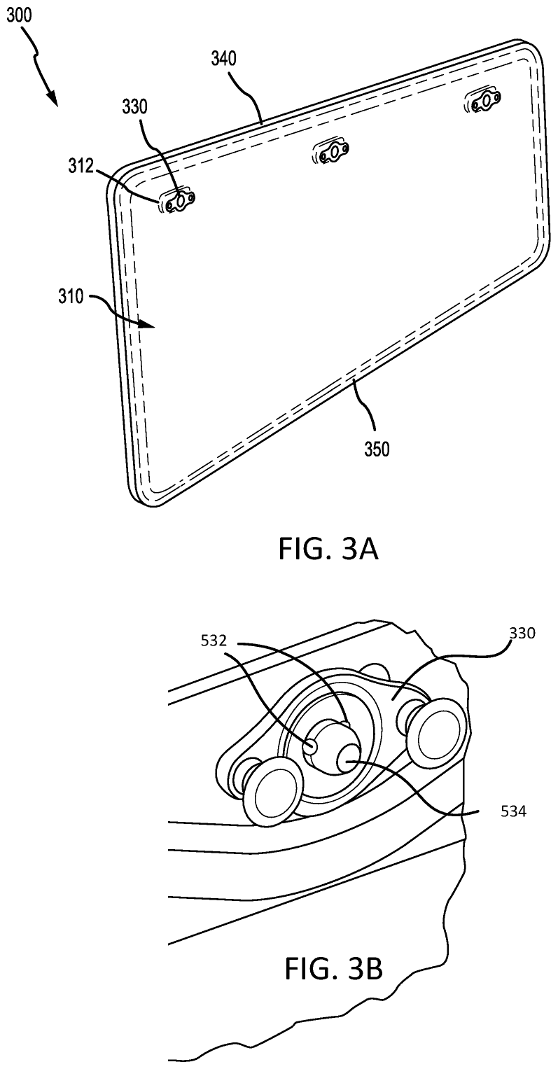

Referring now to FIGS. 3A and 3B, a blowout panel 300 is provided, in accordance with various embodiments. The blowout panel 300 comprises a cover 310. In various embodiments, the cover 310 is made of a composite material, such as glass epoxy, carbon fiber epoxy, or any other material commonly used or known in the art. In various embodiments, the cover 310 comprises a first platform 312 disposed on a first surface of the cover 310. The blowout panel 300 further comprises a first plate 330 disposed on the first platform 312 by any method commonly known in the art, such as a fastened connection, according to various embodiments. The first platform 312 and the first plate 330 are configured to receive an attachment stud (e.g. piston 534 with retention balls 532) of a securing fixture of a packboard, as described in greater detail below. In various embodiments, the blowout panel 300 further comprises a seal 340 extending around the perimeter of cover 310. The seal 340 is bonded to the blowout panel 300 by any method commonly known in the art, such as through adhesive bonding or the like. In various embodiments, the blowout panel includes a bottom edge 350 or lip that is configured to be retained in seated engagement with a corresponding edge of the aircraft.

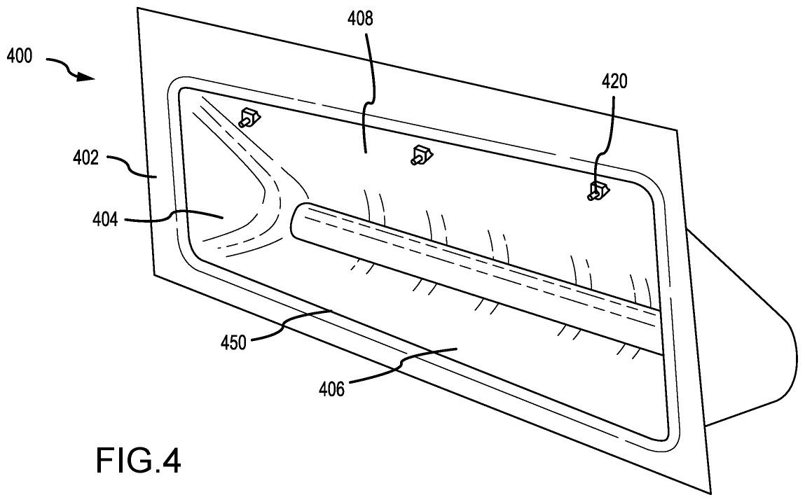

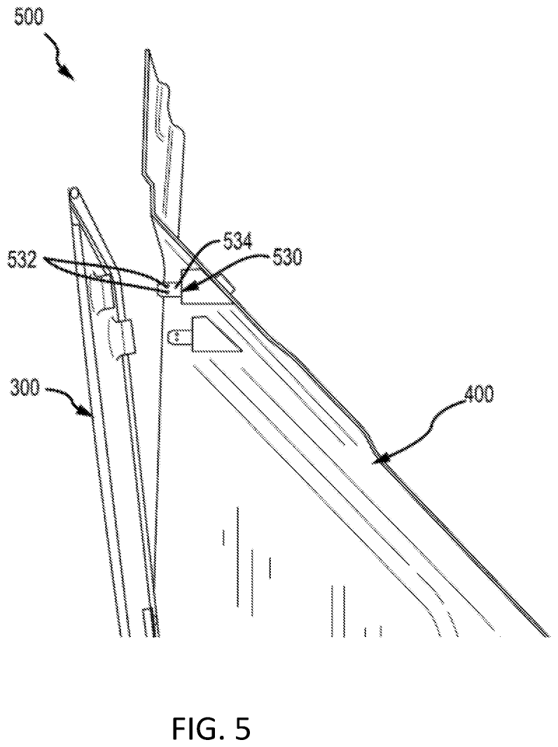

Referring now to FIG. 4, a perspective view of a packboard 400, in accordance with various embodiments, is depicted. The packboard 400 may have a flange 402 and a compartment 404 disposed within the flange and generally defined by the packboard 400. The compartment 404 comprises a bottom panel 406 and a top panel 408. The compartment is configured to receive an evacuation system 100, as described with reference to FIG. 1 above. In various embodiments, the flange 402 and the compartment 404 are a unitary component. The packboard 400 may further have a bottom edge 450 for receiving and retaining the corresponding bottom edge 350 of the blowout panel 300 (FIG. 3A). In various embodiments, the packboard 400 further comprises one or more retention fixtures, such as ball lock 420, disposed proximate a forward edge and a fuselage adjacent edge of the top panel 408 of the packboard 400. With momentary reference to FIGS. 3A, 3B, and 5, the ball lock 420 is configured to reversibly mate with the first plate 330 of the blowout panel 300 and secure the blowout panel 300 to the packboard 400. To release the blowout panel 300 from the packboard 400, the ball lock 420 may be actuated to release the first plate 330 from the ball lock 420.

Referring now to FIG. 5, a side view of a compartment assembly 500 is provided, in accordance with various embodiments. The compartment assembly 500 comprises a blowout panel 300 and a packboard 400. During assembly, the bottom edge/lip 350 (FIG. 3A) of the blowout panel 300 is received by the bottom edge 450 of the compartment of the packboard 400. In various embodiments, after the bottom edge of the blowout panel is received by the bottom edge of the packboard compartment, the blowout panel 300 is pivoted until the top edge of the blowout panel, with the affixed plate 330, engages a respective ball lock 530 on the packboard 400. For example, the ball lock 530 may include a piston 534 having one or more balls 532 disposed circumferentially around the piston 534. The balls 532 may be compressed upon insertion of the piston through the plate 330 until the balls pass through and again release/expand to secure the blowout panel 300 to the packboard 400. The ball lock 530 may be made of composite materials and/or metal materials, such as stainless steel, a nickel alloy, titanium, aluminum, or any metal commonly used in the art.

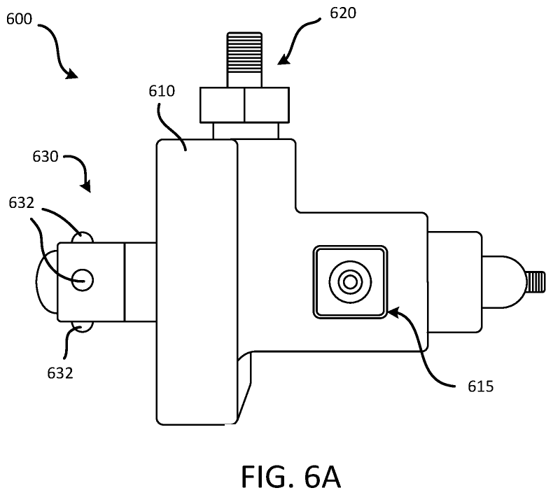

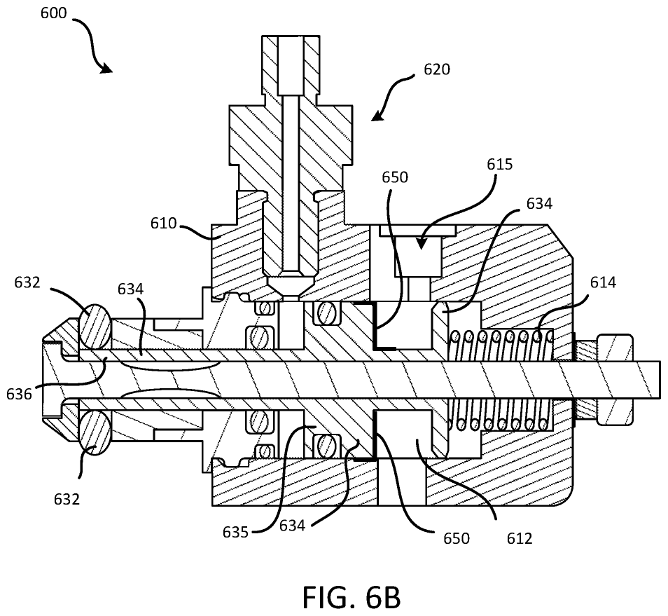

In various embodiments, and with reference to FIGS. 6A and 6B, a ball lock 600 is provided. As mentioned above, the ball lock 600 may generally be coupled to a blowout panel to selectively retain the blowout panel in place. The ball lock 600 may further include an indicator that is configured to be indicative of the locked/unlocked state of the ball lock 600. That is, the indicator may be configured to indicate to a user whether the ball lock 600 is in a locked position (i.e., the blowout panel 300 is properly secured in place) or whether the ball lock 600 is in an unlocked position (i.e., the blowout panel 300 is not properly secured).

The ball lock 600 generally includes a body 610 having a shaft 630 with at least one retention feature 632 disposed at a distal portion of the shaft 630. As mentioned above, the at least one retention feature 632 may include one or more balls that are circumferentially distributed around the shaft 630. These retention feature(s) 632 may be in an expanded state to facilitate secure retention of the blowout panel 300, or the retention feature(s) 632 may be in a compressed state to allow the blowout panel to fall away (i.e., thereby allowing the blowout panel 300 to be jettisoned in response to an evacuation event).

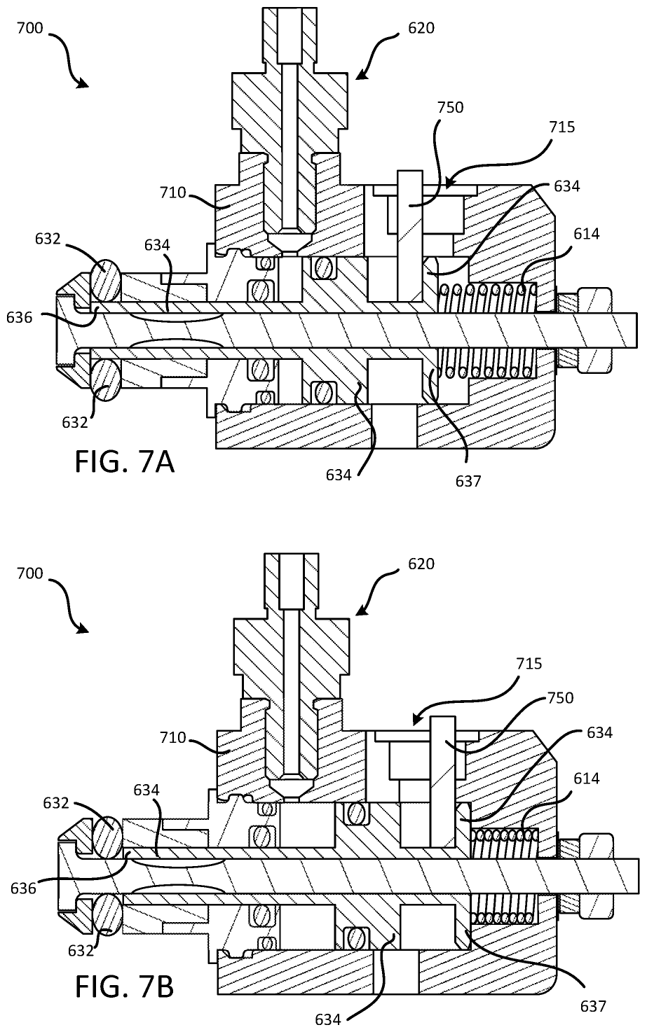

In various embodiments, and with continued reference to FIGS. 6A and 6B, the body 610 of the ball lock 600 defines a central chamber 612 and an access slot 615 that is open to the central chamber 612. The access slot 615 may be a hole or other pass-through aperture for a key actuator. That is, a key or other tool may be insertable through the access slot 615 to manually actuate or otherwise configure or engage a spindle 634 housed within the central chamber 612. Accordingly, the ball lock 600 may include a spindle 634 that is movable within the central chamber 612 of the body 610, and movement of the spindle 634 may be configured to actuate the position of the retention features 632. In other words, with the spindle 634 in a first position (e.g., FIG. 6B) the retention features 632 may be pushed to the expanded state to facilitate retention of the blowout panel and with the spindle 634 in a second position (e.g., FIG. 7B, as described in greater detail below) the retention features 632 are allowed to collapse radially inward toward the axis of the shaft 630 to allow release of the blowout panel. For example, in response to the spindle 634 being in a locked position within the central chamber 612, the distal end 636 of the spindle 634 engages the at least one retention feature 632 to hold the at least one retention feature 632 in an expanded state, wherein in response to the spindle 634 being in an unlocked position within the central chamber 612, the distal end 636 of the spindle 634 is withdrawn from (e.g., moved away from) the at least one retention feature 632 to allow the at least one retention feature 632 to be in a compressed state.

In various embodiments, the ball lock 600 includes a pneumatic inlet 620 and biasing spring 614. The biasing spring 614 may exert a biasing force on the spindle 634 such that the spindle 634 is biased toward the locked position. In response to introduction of compressed air or other fluid via the pneumatic inlet 620, the biasing force of the spring 614 may be overcome, and the spindle may be translated within the central chamber 612 to the unlocked position (e.g. FIG. 7B). The spindle 634 may accordingly have a piston/flange element 635 dividing the central chamber 612 into two sub-chambers.

In various embodiments, the ball lock 600 further includes an indicator 650. The indicator 650 may be a portion of, or may be coupled to, the spindle 634. The indicator 650, according to various embodiments, may be viewable to a user via the access slot 615. Accordingly, the indicator 650 may be configured to indicate to the user whether the ball lock 600 (i.e., the spindle 634) is in the locked position or the unlocked position. The indicator 650 may comprise a colored pattern, a series of numbers/letters, and/or one or more symbols that are indicative the position of the spindle. For example, the indicator 650 may comprise a segment of the spindle that has a first color section (e.g., green) and a second color section (e.g., red). With the first color section being visible via the access slot 615 defined in the body 610 of the ball lock 600, a user may determine that the ball lock 600 is in the locked position. However, with the second color section being visible via the access slot 615, the user may determine that the ball lock 600 is in the unlocked position, and thus further work/inspection may be performed to ensure the blowout panel is securely retained before flight.

In various embodiments, and with reference to 6B, the indicator 650 may be a sleeve or other feature that is coupled to a portion of the spindle 634. Similar to the configuration described above, depending on which portion of the sleeve is visible via the access slot 615, or depending on whether the sleeve is visible or not, the indicator 650 may indicate to a user the position/state of the ball lock, thus preventing inadvertent detachment of the blowout panel 300.

In various embodiments, and with reference to FIGS. 7A and 7B, the indicator of the ball lock 700 includes a tab 750 extending from the spindle 634 through the access slot 715. The tab 750 may extend out from the central chamber through the access slot 715 so as to be generally visible to a user viewing the ball lock 700 from nearly any angle. That is, instead of the user having to specifically position himself/herself to look down through the access slot to view the spindle and/or the attached sleeve, the position of the protruding tab 750 relative to the exterior surface of the body 710 of the ball lock 700 may indicate the position of the spindle 634. Accordingly, the tab 750 may be configured to move/translate with the spindle, and thus the access slot 715 may be elongated (when compared to the access slot 615). In various embodiments, the exterior surface of the ball lock 700 around the access slot 715 may include indicating lines or features to indicate the position of the spindle 634. In various embodiments, the indicator tab 750 is viewable from an inboard position relative to the aircraft.

In various embodiments, and with continued reference to FIGS. 7A and 7B, the locked an unlocked positions of the ball lock 700 are provided. More specifically, FIG. 7A shows the spindle 634 in a first position within the central chamber defined by the body 710 of the ball lock 700, with distal end 636 of the spindle 634 engaging and pushing the retention features 632 to the expanded state (e.g., the locked position). Correspondingly, FIG. 7B shows the spindle 634 in a second position within the central chamber, with the distal end 636 of the spindle 634 moved away from the retention features 632 to allow the retention features 632 to return to their default compressed state (e.g., the unlocked position), according to various embodiments.

In various embodiments, the spindle 634 comprises a proximal end 637. The proximal end 637 may be engaged against biasing spring 614. That is, the proximal end 637 of the spindle 634 may have a first surface that faces the biasing spring 614 and a second surface opposite the first surface. The tab 750 may be coupled to and/or may extend from the second surface.

In various embodiments, instead of the indicator being a physical element that is manually viewable by a user, the indicator may be a sensor, such as a position sensor, that automatically detects the position of the spindle to determine the locked/unlocked state of the ball lock. For example, the ball lock 700 may include a position sensor (in place of or in addition to the above described physical indicator). The position sensor may be configured to detect the position of the spindle and/or to directly detect the position of the retention features. In various embodiments, the position sensor may be coupled in electronic control communication with an aircraft controller. That is, the position sensor may generate a feedback control signal that is utilized by one or more controllers of the aircraft.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure.

The scope of the disclosure is accordingly to be limited by nothing other than the appended claims, in which reference to an element in the singular is not intended to mean “one and only one” unless explicitly so stated, but rather “one or more.” It is to be understood that unless specifically stated otherwise, references to “a,” “an,” and/or “the” may include one or more than one and that reference to an item in the singular may also include the item in the plural. All ranges and ratio limits disclosed herein may be combined.

Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

The steps recited in any of the method or process descriptions may be executed in any order and are not necessarily limited to the order presented. Furthermore, any reference to singular includes plural embodiments, and any reference to more than one component or step may include a singular embodiment or step. Elements and steps in the figures are illustrated for simplicity and clarity and have not necessarily been rendered according to any particular sequence. For example, steps that may be performed concurrently or in different order are illustrated in the figures to help to improve understanding of embodiments of the present disclosure.

Any reference to attached, fixed, connected or the like may include permanent, removable, temporary, partial, full and/or any other possible attachment option. Additionally, any reference to without contact (or similar phrases) may also include reduced contact or minimal contact. Surface shading lines may be used throughout the figures to denote different parts or areas but not necessarily to denote the same or different materials. In some cases, reference coordinates may be specific to each figure.

Systems, methods and apparatus are provided herein. In the detailed description herein, references to “one embodiment”, “an embodiment”, “various embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element is intended to invoke 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A ball lock comprising:
a body comprising a shaft having at least one retention feature disposed at a distal portion of the shaft, the body defining a central chamber and an access slot open to the central chamber;
a spindle disposed within the central chamber of the body, the spindle comprising a distal end configured to selectively engage the at least one retention feature disposed at the distal portion of the shaft, wherein in response to the spindle being in a locked position within the central chamber, the distal end of the spindle engages the at least one retention feature to hold the at least one retention feature in an expanded state, wherein in response to the spindle being in an unlocked position within the central chamber, the distal end of the spindle is withdrawn from the at least one retention feature to allow the at least one retention feature to be in a compressed state; and
an indicator coupled to the spindle and viewable to a user via the access slot, wherein the indicator is configured to indicate to the user whether the spindle is in the locked position or the unlocked position.

2. The ball lock of claim 1, wherein the indicator comprises at least one of a colored pattern, a series of numbers/letters, and one or more symbols viewable through the access slot to indicate whether the spindle is in the locked position or the unlocked position.

3. The ball lock of claim 2, wherein the indicator is a section of the spindle.

4. The ball lock of claim 2, wherein the indicator is a sleeve coupled to a section of the spindle.

5. The ball lock of claim 4, wherein the access slot is a hole for insertion of a key actuator.

6. The ball lock of claim 1, wherein the indicator comprises a tab extending from the spindle through the access slot, wherein a position of the tab relative to the access slot is indicative of whether the spindle is in the locked position or the unlocked position.

7. The ball lock of claim 6, wherein the spindle comprises a proximal end having a first surface facing a biasing spring and a second surface opposite the first surface, wherein the tab extends from the second surface.

8. The ball lock of claim 1, wherein the indicator is a position sensor configured to detect a position of the spindle.

9. An evacuation assembly of an aircraft, the evacuation assembly comprising:
a packboard comprising a top panel and a bottom panel that collectively define a compartment;
a ball lock coupled to the top panel of the packboard; and
a blowout panel selectively coupled to the ball lock;
wherein the ball lock comprises an indicator configured to indicate to a user whether the ball lock is in a locked position or an unlocked position.

10. The evacuation assembly of claim 9, wherein the indicator is viewable by the user from an inboard position relative to the aircraft.

11. The evacuation assembly of claim 9, wherein the ball lock comprises:
a body comprising a shaft having at least one retention feature disposed at a distal portion of the shaft, the body defining a central chamber and an access slot open to the central chamber; and
a spindle disposed within the central chamber of the body, the spindle comprising a distal end configured to selectively engage the at least one retention feature disposed at the distal portion of the shaft, wherein in response to the spindle being in the locked position within the central chamber, the distal end of the spindle engages the at least one retention feature to hold the at least one retention feature in an expanded state, wherein in response to the spindle being in the unlocked position within the central chamber, the distal end of the spindle is withdrawn from the at least one retention feature to allow the at least one retention feature to be in a compressed state.

12. The evacuation assembly of claim 11, wherein the indicator comprises at least one of a colored pattern, a series of numbers/letters, and one or more symbols viewable through the access slot to indicate whether the spindle is in the locked position or the unlocked position.

13. The evacuation assembly of claim 12, wherein the indicator is a section of the spindle.

14. The evacuation assembly of claim 12, wherein the indicator is a sleeve coupled to a section of the spindle.

15. The evacuation assembly of claim 14, wherein the access slot is a hole for insertion of a key actuator.

16. The evacuation assembly of claim 11, wherein the indicator comprises a tab extending from the spindle through the access slot, wherein a position of the tab relative to the access slot is indicative of whether the spindle is in the locked position or the unlocked position.

17. The evacuation assembly of claim 16, wherein the spindle comprises a proximal end having a first surface facing a biasing spring and a second surface opposite the first surface, wherein the tab extends from the second surface.

18. The evacuation assembly of claim 9, wherein the indicator is a position sensor configured to detect a position of the spindle.

19. The evacuation assembly of claim 18, wherein the position sensor is configured to send a feedback control signal to an aircraft controller.

20. An aircraft comprising:
an evacuation slide held in a stored state within
a compartment of a packboard, the packboard comprising a top panel and a bottom panel that collectively define the compartment;
a ball lock coupled to the top panel of the packboard;
a position sensor coupled to the ball lock; and
a blowout panel selectively coupled to the ball lock;
wherein the position sensor is configured to detect a position of the ball lock and to send a feedback control signal to an aircraft controller.
